(19) United States
(12) Patent Application Publication
(10) Pub. No.: US 2024/0117245 A1
(43) Pub. Date: Apr. 11, 2024

(54) METHODS, SYSTEMS, PRODUCTS AND ARRANGEMENTS FOR CONVERTING PLASTIC WASTE INTO CARBON DOTS

(71) Applicant: New York University Abu Dhabi, Abu Dhabi (AE)

(72) Inventors: MOHAMMED ABDELHAMEED, Abu Dhabi (AE); KHALIL b. RAMADI, Abu Dhabi (AE)

(21) Appl. No.: 18/377,553

(22) Filed: Oct. 6, 2023

Related U.S. Application Data
(60) Provisional application No. 63/414,059, filed on Oct. 7, 2022.

(51) Int. Cl. C09K 11/06

(52) U.S. Cl. CPC C09K 11/06; C01P 2002/82; C01P 2004/04; C01P 2004/64; C09K 2211/1003

(57) ABSTRACT

Exemplary methods, systems, products and arrangements for converting a product containing a plastic such as polyolefin into a product containing carbon and oxygen such as carbon dots and carbon dots configured to emit a blue light can be provided. For example, it is possible to convert a product containing a polyolefin into carbon dots. For example, it is possible to perform a hydrothermal reaction on a mixture comprising the product containing the polyolefin, nitric acid and water at a temperature in a range of between about 160° C. and 220° C. to obtain the carbon dots.

### CROSS-REFERENCE TO RELATED APPLICATION(S)

This application relates to and claims priority from U.S. Patent Application No. 63/414,059, filed on Oct. 7, 2023, the entire disclosure of which is incorporated herein by reference.

### FIELD OF THE DISCLOSURE

The present disclosure relates to the technical field of plastic and mask recycling and upcycling, and specifically to exemplary embodiments methods, systems, products and arrangements for converting a plastic waste, e.g., a polyolefin waste, such as a polyethylene plastic waste, or a polypropylene mask waste, or a polyethylene terephthalate (PET) waste, or a combination thereof, into a product containing carbon and oxygen, such as carbon quantum dots, e.g., fluorescent carbon dots, and a product containing a dicarboxylic acid compound, etc.

### BACKGROUND INFORMATION

The use of disposable plastics has surged during the COVID-19 pandemic. These plastics include medical waste generated by hospitals, personal protection equipment (e.g. surgical masks), and online-shopping package materials (e.g., plastic bags).¹ It is estimated that around 26,000 metric tons of pandemic-related plastic waste has been released into the world's oceans since the start of the COVID-19 pandemic. Plastic packaging creates significant negative externalities valued at USD 40 billion by the United Nations Environment Programme (UNEP). Only 14% of all plastic packaging is recycled globally, with the rest escaping into the environment.² These materials are harmful to humans and the environment. Indeed, such materials can be consumed by organisms or fragment into micro- and nano-plastics, threatening terrestrial, marine, and freshwater ecosystems, and ultimately human health.^{3,4} Thus, there is a need to provide simple and convenient method, systems, products and arrangements for recycling and increasing the added value of these waste plastics.

Many single-use plastics are manufactured from polyolefins such as polypropylene and polyethylene.⁵ Surgical masks, for example, are most commonly made of polypropylene (PP) polymer as it is cheap, easy to process, and possesses dielectric properties.⁶ These masks, however, are difficult to recycle and are not biodegradable.^{3,7} Prior efforts to upcycle plastic waste include converting plastic into lubricant and waxes,⁸ biofuels,⁹ construction materials,¹⁰ and combustible gases.¹¹ Unfortunately, these prior methods have proven too fragmented and uncoordinated to have impact at scale.¹²

Carbon dots (CDs) are luminescent zero-dimensional carbon nanomaterials that retain unique physical and chemical properties, good biocompatibility, low toxicity, and easy-to-functionalize surface¹³. These properties have made them attractive agents for use in biological imaging,¹⁴ environmental monitoring,¹⁵ chemical analysis,¹⁶ targeted drug delivery,¹⁷ disease diagnosis and therapy,¹⁸ and anti-counterfeiting applications.¹⁹ A cost-effective means to upcycling of plastic waste into carbon dots would create value-added products in addition to reducing total waste. Previous studies have attempted to convert plastic waste into carbon dots. These studies include the use of air oxidation of polyethylene terephthalate (PET) following hydrothermal treatment in sulfuric acid or aqueous H₂O₂ solution^{20,21}, thermal calcination of plastic waste in inert atmosphere followed by mechanical crushing²², hydrolytic degradation of polylactide over multiple weeks followed by hydrothermal processing²³, thermal calcination followed by hydrothermal processing²⁴, dissolving polystyrene foam in dichloroethane, with subsequent hydrothermal processing²⁵, and dissolving expanded polystyrene foam in dichloromethane and 5% ethylenediamine (EDA)²⁶. These processes all invariably involve two or more steps, utilize toxic chemicals and solvents (e.g. dichloromethane), and can take up to multiple weeks to break down plastics.

Accordingly, there may be a need to address and/or at least partially overcome at least some of the prior deficiencies described herein.

### SUMMARY OF EXEMPLARY EMBODIMENTS

To at least partially address and/or overcome such issues and/or deficiencies, methods, systems, products and arrangements for converting a product containing a plastic, e.g., polyolefin, into a product containing carbon and oxygen, such as carbon dots, or a dicarboxylic acid compound, can be provided according to certain exemplary embodiments of the present disclosure. Such exemplary methods, systems, products and arrangement can be utilized to, e.g., perform and/or effectuate a hydrothermal reaction on a mixture containing the product containing the plastic, an acid such as nitric acid and water at a temperature in a range of, e.g., between about 160° C. to 220° C. to obtain a reaction product containing carbon and oxygen, such as carbon dots or a dicarboxylic acid compound, although other temperature ranges are conceivable in the context of the present disclosure.

According to an exemplary embodiment of the present disclosure, the reaction product contains at least one of C—C, C═C, C—O, C═O, —OH, —COOH, or a combination thereof.

According to an exemplary embodiment of the present disclosure, a one-pot process, system, product and arrangement for converting a product containing a plastic such as a polyolefin into carbon dots can be provided.

According to an exemplary embodiment of the present disclosure, a one-pot process, system, product and arrangement for converting a product containing PET into a dicarboxylic acid compound can be provided.

In another exemplary embodiment of the present disclosure, the mixture containing the plastic, an acid such as nitric acid and water does not contain or excludes any solvent other than water. According to an exemplary embodiment of the present disclosure, the mixture contains no organic solvent. As such, the methods, systems, products and arrangements according to various exemplary embodiments of the present disclosure do not utilize or exclude toxic chemicals or toxic organic solvents, such as dichloromethane, and are thus less polluting than the existing methods, systems, products and arrangements.

According to yet another exemplary embodiment of the present disclosure, the exemplary system, product and arrangement containing the plastic, e.g., polyolefin comprises polyethylene, polypropylene, or polyethylene terephthalate (PET), or a combination thereof can be provided. The exemplary system, product and arrangement containing the plastic, e.g., polyolefin can be or include, e.g., a polyethylene-based plastic bag waste or a polypropylene-based mask waste, or a polyethylene terephthalate (PET)-based waste. The polyethylene-based plastic bag waste or the polypropylene-based mask waste, or the polyethylene terephthalate (PET)-based waste can contain an organic contaminant.

In still another exemplary embodiment of the present disclosure, method, system and arrangement can be provided for converting a product containing a plastic, e.g., polyolefin, into carbon dots configured to emit a blue light, which can be used to perform a hydrothermal reaction on a mixture comprising, consisting essentially of, or consisting of the product containing the plastic, e.g., polyolefin, and an aqueous solution consisting of 0.15 g/ml nitric acid and water, at a temperature of about 180° C. for about 12 hours to obtain the carbon dots configured to emit a blue light, wherein the mixture contains no solvent other than water.

According to further exemplary embodiments of the present disclosure, blue-emissive carbon dots with excitation-dependent emission can be provided.

Exemplary methods, systems and arrangements of the present disclosure can utilize facile, one-pot fabrication of carbon dots by immersing a plastic or mask waste in an acid such as nitric acid aqueous solution to obtain a mixture, and performing a hydrothermal reaction on the resulting mixture to obtain a solution containing carbon dots. According to an exemplary embodiment of the present disclosure, methods, systems and arrangements with, e.g., about 96% production yield can be provided. Exemplary methods, systems and arrangement for further processing such as purification via centrifugation and dialysis can be used to obtain pure fluorescent carbon dots (CDs). The exemplary embodiments of the present disclosure also can exemplify a potential large-scale use case of the resulting fluorescent CDs as anti-counterfeiting agents.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIGS. 1A-1F are exemplary graphs of effects of HNO₃ concentration, whereas FIGS. 1A and 1B are the exemplary graphs for plastic bag and mask, respectively for specific concentrations, FIGS. 1C and 1D for plastic bag and mask, respectively, for specific temperatures, and FIGS. 1E and 1F are exemplary graphs for reaction duration for plastic bag and mask, respectively on the fluorescence of the produced CDs for specific reaction times;

FIGS. 2A-2F are exemplary graphs of properties of CDM (Carbon dots made from Masks) and CDP (Carbon dots made from Plastic), whereas FIG. 2A is an exemplary normalized absorption and photoluminescence of CDP, FIG. 2B is an exemplary graph of excitation-dependent emission of CDP; FIG. 2C is an exemplary graph of normalized absorption and photoluminescence of CDM, FIG. 2D is an exemplary graph of excitation-dependent emission of CDM, FIG. 2E is an exemplary graph of photostability of CDM and CDP, and FIG. 2F is an exemplary graph of thermal stability test of CDM and CDP under continuous irradiation at an excitation wavelength of 400 and 380 nm, respectively;

FIGS. 3A and 3B are exemplary illustration of diameter distribution and TEM of CDP, respectively, whereas insets in FIG. 3B shows exemplary HR-TEM photographs for solutions under UV (365 nm) irradiation;

FIGS. 3C and 3D are exemplary illustrations of diameter distribution and TEM of CDM, respectively, whereas insets in FIG. 3D show exemplary HR-TEM photographs for solutions under UV (365 nm) irradiation;

FIG. 4A is a graph of exemplary FTIR spectra of polyethylene, CDPC (carbon dots made from plastic contaminated with organic contaminants), CDP, and plastic bag;

FIG. B is a graph of the exemplary FTIR spectra of polypropylene, CDMC (carbon dots made from masks contaminated with organic contaminants), CDM, and mask;

FIGS. 4C-4H are exemplary graphs showing analysis results of CDP or CDM, whereas FIG. 4C is a graph of XPS spectra of survey scans for CDP, FIG. 4D is a graph of C 1s, FIG. 4E is a graph of O 1s, FIG. 4F is a graph of XPS spectra of survey scans for CDM, FIG. 4G is a graph of C 1s, and FIG. 4H is a graph of O 1s;

FIGS. 5A-5F are exemplary graphs of optical and mechanical characterization test results on exemplary PDMS samples with varying CDP concentrations (10:0 (I), 10:1 (II), 5:1 (III), and 3.3:1 (IV) of PDMS:CDP). whereas FIG. 5A is an exemplary graph of control and CDP-doped PDMS films under visible (left) and UV light (right) for PDMS only (I), PDMS mixed with CDP in a ratio of (10:1, II), (5:1, III), and (3.3:1, IV), FIG. 5B is an exemplary graph of fluorescent confocal microscope images collected at an excitation wavelength of 470 nm (scale bars=5 μm), FIG. 5C is an exemplary graph of excitation-dependent emission collected at 405, 470 488 and 514 nm for sample II, FIG. 5D is an exemplary graph of force-displacement responses for the four samples, FIG. 5E is an exemplary graph of the set-up used for material characterization where samples were displaced by 30 mm, and FIG. 5F is an exemplary graph of the stress-strain response for sample II;

FIG. 6 is an exemplary diagram of an exemplary method/process for converting plastic wastes into blue-emissive carbon dots according to exemplary embodiments of the present disclosure;

FIG. 7 is an exemplary illustration an exemplary Synthetic route to produce CDs from plastics (Scheme 1) according to exemplary embodiments of the present disclosure;

FIGS. 8A and 8B are exemplary graphs of emission-dependent excitation and excitation-dependent emission of CDP and CDM, respectively;

FIGS. 9A and 9B are exemplary graphs of emission-dependent excitation and excitation-dependent emission of CDPC and CDMC, respectively;

FIGS. 10A and 10B are exemplary graphs of photostability test results of CDM and CDP under continuous UV irradiation, respectively;

FIGS. 10C and 10D are exemplary graphs of thermal stability of CDM and CDP at different temperatures, respectively;

FIG. 11 is an exemplary graph of photoluminescence intensity of CDP and CDM at different weights of plastic and mask loads using small (100 ml) and large (200 ml) autoclave reactors;

FIGS. 12A and 12B are exemplary graphs of MTT assay results on the viability of HeLa cells after exposure to different concentrations (0.1, 0.25, 0.5, 1, and 2 mg/ml) of CDP after 4 hours of incubation and after 24 hours of incubation, respectively;

FIGS. 13A-13D are exemplary graphs of cyclical deformation responses of the QD doped PDMS, whereas FIG. 13A is an exemplary graph of cyclical force-displacement response for the PDMS only control samples, FIG. 13B is an exemplary graph of cyclical force-displacement response for the PDMS+QD (10:1) samples, FIG. 13C is an exemplary graph of cyclical force-displacement response for the PDMS+QD (5:1) samples, and FIG. 13D is an exemplary graph of cyclical force-displacement response for the PDMS+QD (3.3:1) samples; and

FIG. 14 is an exemplary graph of an exemplary FTIR spectrum of a product obtained by performing a hydrothermal procedure on a plastic bottle containing PET.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

Plastics have several excellent properties that have popularized their use for various applications such as packaging (see Reference 5) and construction materials, (see Reference 55) textiles, (see Reference 56) electronics, (see Reference 57) and industrial machinery (see Reference 58). This is due to their low cost, light weight, high strength-to-weight ratio, bio-inertness, and high corrosion resistance in various media. Polyethylene is one of the world's most widely produced plastics (see Reference 2). Hence, polyethylene plastics have the potential to be very resource efficient (see Reference 2).

Polypropylene is the second most commonly used plastic after polyethylene. In addition to its suitability as a structural plastic, it can be also used as a fiber (see Reference 6). It is a basic input for surgical masks. Polypropylene polymers are processed through a melt-blown process in order to obtain fibers of a small diameter in a random pattern that can trap small particles (see Reference 59) Therefore, polypropylene demand has surged since 2019 across the globe due to the growing need for face masks as a result of the Covid-19 pandemic.

Plastic packaging creates significant negative externalities, valued at USD 40 billion as estimated by the United Nations Environment Programme (UNEP). Only 14% of all plastic packaging is recycled globally, and the rest escapes into the environment causing a harmful impact (see Reference 2). This leads to a loss of USD 80 to 120 billion per year, and if this trend continues, there would be more plastic than fish in the ocean by 2050 (see Reference 2). Disposable plastic and mask wastes cannot be easily biodegraded, and they may fragment into tiny particles in micro- and nano-scale that widespread in the ecosystem (see References 3 and 4). This poses a threat to terrestrial, marine, freshwater ecosystems and large numbers of organisms, including humans. Therefore, there is a need to develop a simple and convenient method for increasing the added value of these waste plastics.

There are various innovative technologies and improvement efforts that have the potential to transfer and boost the plastic economy. Unfortunately, these techniques have proven to be too fragmented and uncoordinated to have impact at scale (see Reference 60). This includes converting plastic into lubricant and waxes, biofuels, components of building construction, and combustible gases (see References 8-11). Furthermore, upcycling contaminated plastics with organic waste into useful products is a major challenge due to the extra cost related to the need for cleaning the plastic prior to processing (Reference 61).

Carbon dots, as a type of luminescent zero-dimensional carbon nanomaterial, have recently attracted great interest because of their suitability for various biological imaging, environmental monitoring, chemical analysis, targeted drug delivery, and disease diagnosis and therapy applications (Reference 62). This is assigned to their unique physical and chemical properties, good biocompatibility, low toxicity, and easy surface functionalization.

The COVID-19 pandemic has led to unprecedented demand for single use plastics such as plastic bags and surgical masks. Plastics are resistant to natural degradation and are a significant environmental pollution problem globally, threatening the environment and human health. Finding suitable ways to convert plastic waste into valuable materials is crucial to mitigate these effects.

In order to reduce and solve the harmful impacts of plastic and mask waste to the environment and enhance their added value, according to an exemplary embodiment of the present disclosure, can be provided methods, including but not limited to, a facile one-pot method for the preparation of fluorescent carbon dots from plastic bags and masks as starting materials.

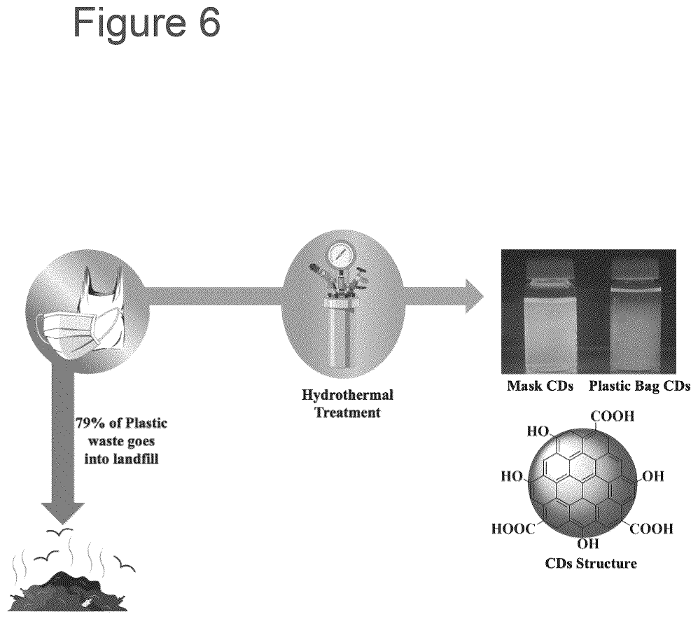

According to an exemplary embodiment of the present disclosure, a procedure to create fluorescent carbon dots (CDs) from a plastic waste can be provided, which can be, e.g., a single-step procedure (see, e.g., FIG. 6). The exemplary synthesis methods, systems, products and arrangements according to exemplary embodiments of the present disclosure can be cost-effective, easy to implement, highly scalable, and contamination-resistant processes, systems, products and arrangements to upcycle plastic waste.

Carbon dots can be synthesized in an exemplary process from a product containing a plastic, such as polyethylene plastic bags or polypropylene surgical masks, or a polyethylene terephthalate (PET)-based waste, using an oxidative hydrothermal approach. According to an exemplary embodiment of the present disclosure, the exemplary method, system and arrangement can achieve a 96% production yield. The resulting CD products can be highly soluble in water, alcohol and various organic solvents, and can show excitation-dependent emission consistent with an average particle size of 1 nm to 8 nm, or 3 nm to 8 nm, as determined, e.g., by the Transmission Electron Microscope (TEM) method. High-resolution TME (HRTEM) demonstrated that both CDs have similar crystallinity with an average lattice spacing of 0.2 nm, assigned to the (100) plane of carbon particles.

In the present disclosure, the term “excitation-dependent emission” may refer to, but is not limited to, the property of photoluminescent materials whereby when they are illuminated with light of a specific wavelength, subsequently emit light of a different wavelength or combination of wavelengths. The excitation-emission relationship is affected by, e.g., the size of CDs. The presence of CDs of various sizes can result in a broad emission spectrum across multiple wavelengths following excitation at a single wavelength. Varying the wavelength of light exciting the material can vary the resulting light emitted by the material.

In certain exemplary embodiments, the carbon dots can emit light having a peak emission wavelength in a range of 340 nm to 490 nm when excited by light having a peak wavelength in a range of 320 nm to 470 nm.

In certain exemplary embodiments, such exemplary oxidative degradation method, system and arrangement can upcycle contaminated plastics with organic waste, which was a major challenge with plastic recycling.

The CDs according to an exemplary embodiment of the present disclosure can be used as anti-counterfeiting labels by doping polydimethylsiloxane (PDMS) films.

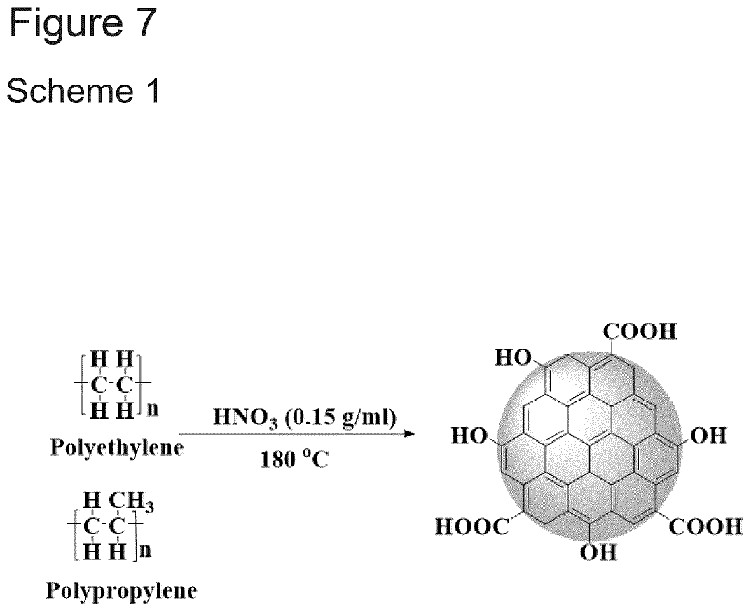

According to an exemplary embodiment of the present disclosure, carbon dots can be synthesized from a polyethylene-based plastic bag waste and a polypropylene-based mask waste following a solvent-free, relatively low-temperature, and one-step oxidative hydrothermal procedures using a diluted nitric acid solution (0.15 g/ml) (Scheme 1; FIG. 7). Polyethylene plastic bags could be converted into dicarboxylic acid using a microwave-assisted process 27.

Dicarboxylic acid is a precursor to certain quantum dots. According to an exemplary embodiment of the present disclosure, it has been determined that a similar approach with more uniform hydrothermal processing can yield a direct conversion of plastics to carbon dots.

According to an exemplary embodiment of the present disclosure, the products can be characterized using high-resolution transmission electronic microscopy (HRTEM), Fourier-transform infrared (FTIR) spectroscopy, X-ray photoelectron spectroscopy (XPS), UV-Vis absorption spectroscopy, and steady-state and times-resolved emission spectroscopy.

### Exemplary Synthesis Procedure

It has been determined, according to exemplary embodiments of the present disclosure, whether a single-step hydrothermal reaction in diluted acid could breakdown plastic wastes, such as polyethylene-based plastic bags, or a polypropylene-based mask waste, or a polyethylene terephthalate (PET)-based waste, into nanoparticles, and the reaction parameters of concentration, temperature, and time have been optimized.

Methods, systems and arrangements according to an exemplary embodiment of the present disclosure can perform a hydrothermal reaction on a mixture containing the product containing the plastic, e.g., polyolefin, an acid, and water to obtain a reaction product containing carbon and oxygen, e.g., the carbon dots, or a dicarboxylic acid compound, which can be further converted into carbon dots. In certain exemplary embodiment, it is also possible to provide a mixture containing the product containing the plastic, e.g., polyolefin, nitric acid and water by mixing the product containing the plastic, e.g., polyolefin, and an aqueous solution of nitric acid.

In the present disclosure, the term “hydrothermal reaction” may refer to, but is not limited to, a chemical reaction that occurs in water in a sealed pressure vessel, such that it occurs at an elevated temperature and pressure.

According to an exemplary embodiment of the present disclosure, the acid may be nitric acid, hydrochloric acid, or sulfuric acid, or a combination thereof. The mixture comprising the product containing the plastic, the acid and water can be provided by mixing the product containing the product containing the plastic with an aqueous solution containing the acid.

According to an exemplary embodiment of the present disclosure, the content of the product containing the plastic in the mixture comprising the product containing the plastic, the acid and water can be 90% to 96% by weight, relative to the total weight of the mixture.

According to an exemplary embodiment of the present disclosure, the content of the acid in the mixture comprising the product containing the plastic, the acid and water can be 10% to 25% by weight, relative to the total weight of the mixture.

According to an exemplary embodiment of the present disclosure, the mixture comprising the product containing the plastic, the acid and water can contain no solvent other than water, or contains no organic solvent.

According to an exemplary embodiment of the present disclosure, the pressure at which the hydrothermal reaction is performed on the mixture comprising a product containing the plastic, the acid and water can be 0.4 MPa or more, and may be 3 MPa or less. For example, the pressure can be in a range of about 0.4 MPa to about 3 MPa, or 0.4 MPa to 1 MPa.

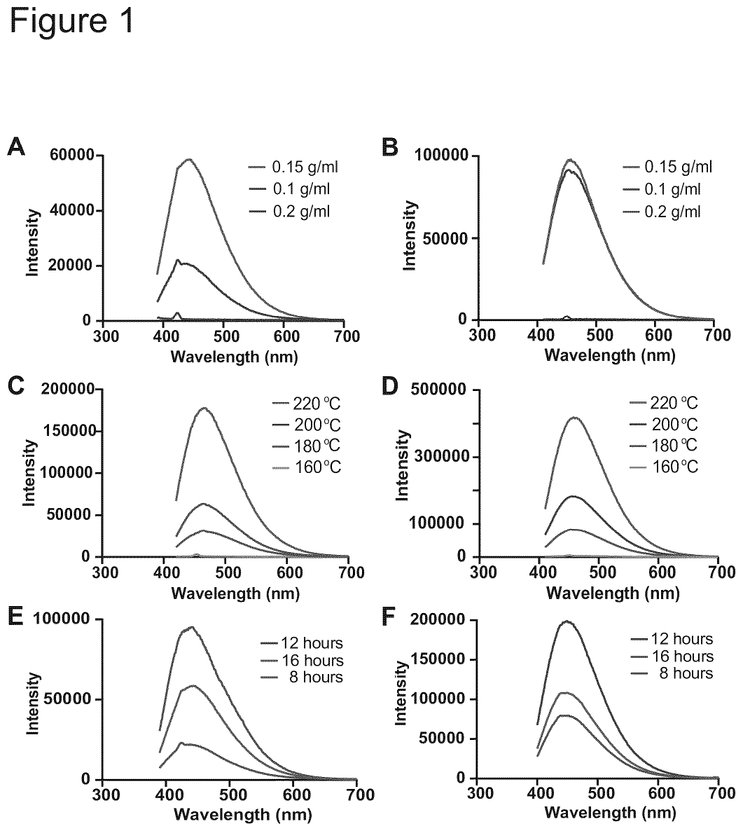

The exemplary concentration of the nitric acid in the aqueous solution of nitric acid can be, about 0.1 g/ml or more, and can be less than about 0.2 g/ml, and preferably, about 0.15 g/ml HNO₃. Lower concentration (0.1 g/ml) of nitric acid solution decreased the fluorescence of CDs, while higher concentrations (0.2 g/ml) resulted in non-fluorescent products for both carbon dots made of plastic bags (CDP) and masks (CDM) (FIG. 1A, 1B).

According to exemplary embodiments of the present disclosure, the hydrothermal reaction can be carried out at a temperature that is more than 160° C., 170° C. or more, or 180° C. or more. According to exemplary embodiments of the present disclosure, the hydrothermal reaction can be carried out at a temperature that is 220° C. or less, or 210° C. or less, or 200° C. or less, or 190° C. or less. For example, the hydrothermal reaction can be carried out at about 180° C. In an exemplary process, carrying out this reaction at 160° C. did not produce any fluorescent product (see FIGS. 1C and 1D). At about 180° C., fluorescent CDs were generated with a reaction yield of 96%. Increasing temperature to 200 and 220° C. increased the fluorescence of products yet decreased reaction yield to 60%. At about 180° C., an optimal balance between a higher reaction yield and reasonable photoluminescence can be achieved.

The hydrothermal reaction can be carried out for any suitable period of time. In terms of maximizing fluorescence, the hydrothermal reaction may be carried out for 8 hours or more and 16 hours or less. For example, the hydrothermal reaction can be carried out for about 12 hours. A reaction time of 12 hours yielded the highest fluorescence, while duration 8 and 16 hours gave a lower fluorescence intensity for both CDP and CDM (see FIGS. 1E and 1F). The reaction yield was over 96% for both CDP and CDM, indicating that the methods, systems and arrangements according to the present disclosure can be suitable for large-scale production of CDs from plastic wastes.

According to an exemplary embodiment of the present disclosure, the exemplary method can comprise, e.g.:
1) immersing 0.5 g of plastic and mask waste into 20 ml of 0.15 g/ml nitric acid solution (mass fraction is 68%) to obtain a raw material mixture;
2) carrying out a hydrothermal reaction for the raw material mixture at 180° C. for 12 hours to get a yellow mixture, such as a solution or a suspension, containing carbon dots; and
3) removing impurities via further processing, such as gravity filtration, and then purifying the carbon dots via dialysis membrane against water to obtain pure carbon dots emitting a blue light or configured to emit the blue light.

Such exemplary procedures can be implemented by the systems and arrangements according to the exemplary embodiments of the present disclosure.

The plastic mass described herein can be from about 0.5 g to 2 g. The concentration of the nitric acid solution used in the exemplary method, system and arrangement can be about 0.1 g/ml to 0.2 g/ml. The temperature at which the hydrothermal reaction is carried out can be from about 160° C. to 220° C. The reaction time for the hydrothermal reaction can be from about 8 hours to 12 hours.

The synthetic methods according to exemplary embodiments of the present disclosure can have the following exemplary advantages:
1) Starting materials are plastic and mask waste that cause environmental pollution and costly to recycle them using conventional methods.
2) It is effective in upcycling contaminated plastics with organic waste.
3) Pretreatment (chemically or thermally) of plastic and mask waste is not needed.
4) Suitable to process different types of polyethylene plastics including Low-density polyethylene (LDPE), High-Density Polyethylene, and Ultra-high-molecular-weight polyethylene (UHMWPE).
5) High yield of the carbon dots (96%).
6) It does not require the use of any organic solvents for the synthesis or purification.
7) Low toxicity of the produced carbon dots that make them suitable for several biological applications.
8) The reaction can be scaled up without significant loss of efficacy or efficiency in creating CDs.

According to certain exemplary embodiments of the present disclosure, a one-pot synthetic method, system and arrangement to convert plastic and mask waste into carbon dots can be provided. The exemplary method, system and arrangement can be facile because there is no requirement of a pre-treatment for plastic waste nor the utilization of any organic solvents, suitable to treat polyethylene, or polypropylene of different molecular weight. This can facilitate a direct conversion of polyethylene and polypropylene waste into carbon dots via a one-pot hydrothermal oxidation, and the upcycling of contaminated plastics with organic waste without pre-treatment. Most of prior carbon dots synthetic methods in the literature involved: 1) using more than one chemicals; or 2) performing two or more hydrothermal treatment cycles; or 3) utilizing a temperature that is higher than what is used in the exemplary embodiments of the present disclosure.

The world produces 381 million tons in plastic waste yearly (see Reference 63), and this number is set to double by 2034. Only 9% is ever recycled. This means that the value of non-recycled plastic packaging—worth some 120 billion dollars—is lost to the economy every year. On the other hand, the market size for quantum dots is expected to reach around USD 8.6 billion by 2026 from USD 4 billion in 2021, at a CAGR of 16.2% during that period. The quantum dots market is driven by their high demand in display devices in addition to their application in quantum computing, second-harmonic generation, solar cells, diode lasers, and medical imaging (see Reference 64). The exemplary methods, systems and arrangements according to the present disclosure for plastics and mask waste recycling to produce carbon dots can have various valuable biological, environmental, and chemical applications.

According to an exemplary embodiment of the present disclosure, a method can be provided for preparing hydrophilic fluorescent carbon dots by using waste polyethylene plastics or polypropylene masks as raw materials, which can comprise:
immersing 0.1 g of waste plastics or masks in 20 ml of nitric acid solution (0.1 g/ml) to obtain a raw material mixture;
carrying out a hydrothermal reaction on the raw material mixture at 180° C. for 12 hours to obtain a mixture, such as a solution or a suspension, containing carbon dots;
removing the solvent in the mixture containing carbon dots to obtain the hydrophilic fluorescent carbon dots.

The methods, systems, products and arrangements described above can be used to convert a product containing polyethylene terephthalate (PET) into chemical compounds having more economic values, such as, e.g., a dicarboxylic acid compound.

According to an exemplary embodiment of the present disclosure, methods, systems, products and arrangements for converting a product containing polyethylene terephthalate (PET) into a dicarboxylic acid compound can be provided. Using such exemplary method, it is possible to perform a hydrothermal reaction on a mixture comprising a product containing polyethylene terephthalate (PET), an acid and water at a suitable temperature, e.g., in a range of between about 160° C. and 220° C., to obtain a reaction product containing a dicarboxylic acid compound. According to certain exemplary embodiments, methods, systems, products and arrangements can be provided for converting the dicarboxylic acid compound into carbon dots.

According to exemplary embodiments of the present disclosure, the hydrothermal reaction can be carried out at a temperature that is more than 160° C., 180° C. or more, or 200° C. or more. According to exemplary embodiments of the present disclosure, the hydrothermal reaction can be carried out at a temperature that is 400° C. or less, or 380° C. or less, or 360° C. or less, or 340° C. or less. For example, the hydrothermal reaction can be carried out at about 160° C. to about 400° C.

According to an exemplary embodiment of the present disclosure, the method may be a one-pot process.

According to an exemplary embodiment of the present disclosure, the acid can be nitric acid, hydrochloric acid, or sulfuric acid, or a combination thereof. The mixture comprising the product containing the PET, the acid and water can be provided by mixing the product containing the PET with an aqueous solution containing the acid.

According to an exemplary embodiment of the present disclosure, the content of the product containing the PET in the mixture comprising the product containing the PET, the acid and water can be 50% to 96% by weight, relative to a total weight of the mixture.

According to an exemplary embodiment of the present disclosure, the content of the acid in the mixture comprising the product containing the PET, the acid and water can be 1% to 50% by weight, relative to the total weight of the mixture.

According to an exemplary embodiment of the present disclosure, the mixture comprising a product containing polyethylene terephthalate, the acid and water can contain no solvent other than water, or contains no organic solvent.

According to an exemplary embodiment of the present disclosure, the pressure at which the hydrothermal reaction can be performed on the mixture comprising a product containing polyethylene terephthalate, the acid and water can be 0.4 MPa or more, and may be 3 Mpa or less. For example, the pressure may be in a range of about 0.4 Mpa to about 3 Mpa.

The dicarboxylic acid may have a composition represented by formula (I):

HOOC—R—COOH (I)
whereas R is an aliphatic group or an aromatic group containing 3 to 7 carbon atoms, optionally substituted with —OH, —C═O, —NH₂, and COOH. Examples of dicarboxylic acids include malonic acid, succinic acid, glutaric acid, adipic acid, and pimelic acid, and combinations thereof. Such exemplary procedures can be implemented by the systems and arrangements according to the exemplary embodiments of the present disclosure.

The exemplary embodiments of the present disclosure can include the following examples, which should not be construed as in any way limiting. The contents of all references, pending patent applications and published patents, cited throughout this application are hereby expressly incorporated by reference. Those skilled in the art will understand that these exemplary embodiments of the present disclosure may be embodied in many different forms and should not be construed as limited to the embodiments set forth herein. Rather, these exemplary embodiments are provided so that the present disclosure conveys the exemplary embodiments of the present disclosure to those skilled in the art. Various exemplary modifications and other exemplary embodiments of the present disclosure will come to mind in one skilled in the art to which this invention pertains having the benefit of the teachings presented in herein. Although specific terms are employed, they are used as in the art unless otherwise indicated.

### Exemplary Carbon Dot Characterization

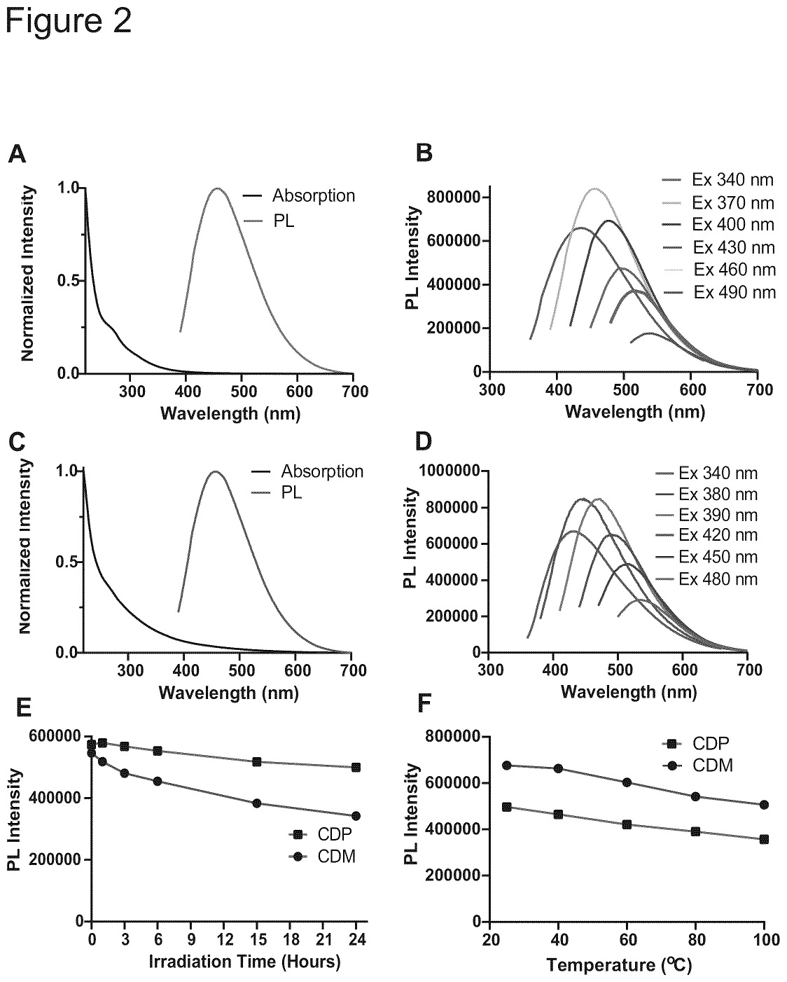

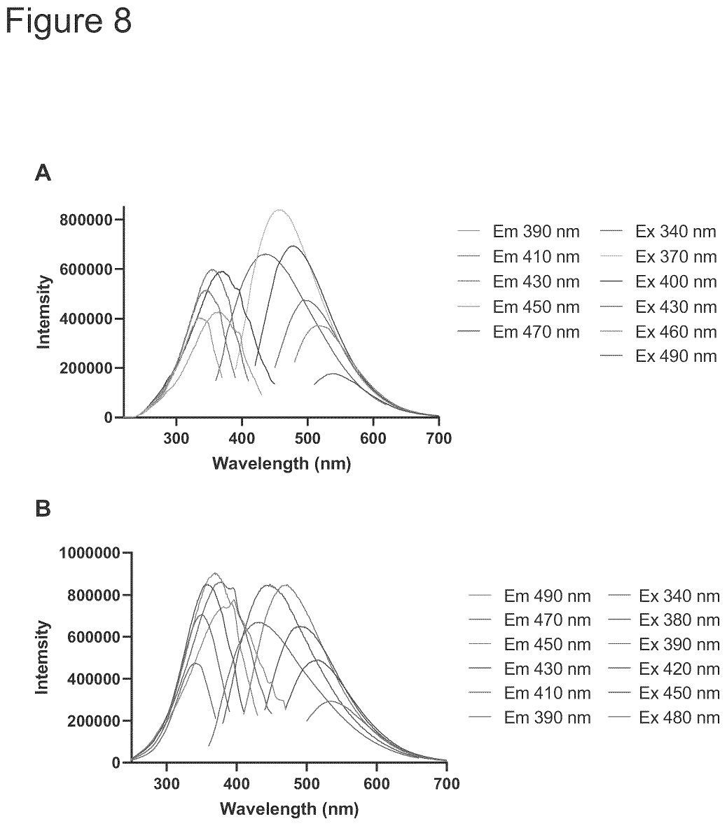

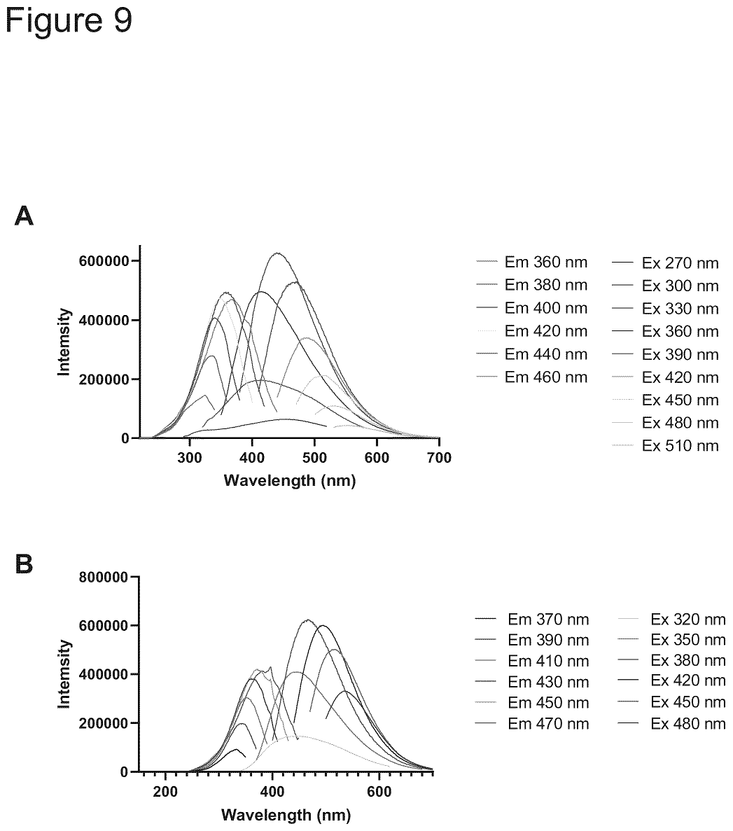

The exemplary UV-Vis absorbance spectra of CDP and CDM (see FIGS. 2A-2F) showed a broad absorption range with typical π-π* transition bands in the UV region. This has been assigned to the complicated band structure and random energy levels of the CDs for CDP and CDM.²⁸ On the other hand, it has been found, according to an exemplary embodiment of the present disclosure, that by increasing the excitation wavelength, the corresponding emission was slightly red shifted. The characteristic of the excitation-dependent emission (see FIGS. 2A-2F) can be attributed to the variability of particle diameters as demonstrated from TEM data for CDP and CDM, availability of SP² sites in addition to the SP³ sites, defects of the structure, as well as the presence of different functional groups on the CDs surface including COOH and OH groups. It has been found, according to an exemplary embodiment of the present disclosure, that the maximum excitation intensity occurred at the wavelength 354 nm and 360 nm when the emission wavelength was set at 430 nm and 450 nm for CDP and CDM, respectively (see FIGS. 8A and 8B). The photoluminescence (PL) spectra of CDP and CDM showed dominant emissions in the blue-green region with a maximum PL intensity centered at 456 and 472 nm, respectively. According to an exemplary embodiment of the present disclosure, the PL properties of the CDP and CDM can be tuned by utilizing different excitation wavelengths, as shown in FIGS. 2A-2F.

### Exemplary Effects of Organic Contaminants

Conventionally, contaminated plastics needed to be cleaned prior to processing because organic contaminants on plastics could significantly impede recycling. This added an extra cost to the recycling process. 29 According to an exemplary embodiment of the present disclosure, a synthesis method, system and arrangement can be provide, which can overcome such challenge. When using plastics with organic contaminants in a plastics hydrothermal processing method in nitric acid, according to an exemplary embodiment of the present disclosure, it has been found that the produced contaminated CDs made of plastic (CDPC) and masks (CDMC) exhibited an excitation-dependent emission and an emission-dependent excitation (FIG. 16). The CDPC showed a maximum excitation and emission intensities at 358 nm and 439 nm, respectively. The CDMC exhibited a maximum excitation and emission intensities at 373 nm and 468 nm, respectively. The PL quantum yields (QYs) of CDP and CDM in methanol was found to be 14.6% and 16%, respectively.

### Exemplary Stability and Scalability

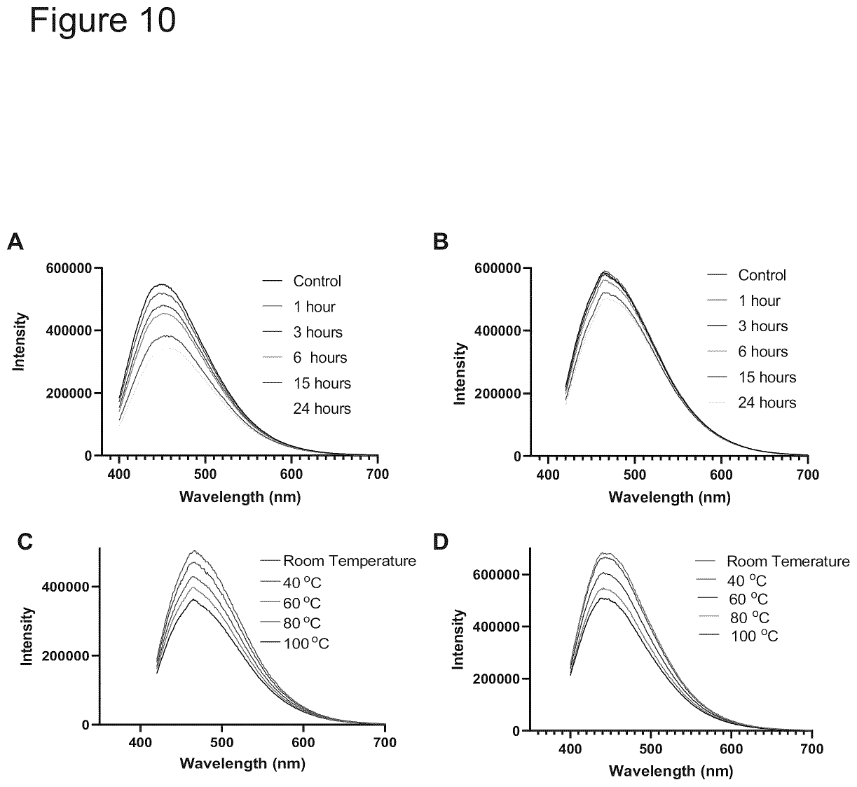

According to an exemplary embodiment of the present disclosure, the stability of CDM and CDP samples across conditions has been investigated. For example, the photostability has been tested by exposing CDM and CDP samples to 25 mW cm⁻² UV illumination from a 250 W power mercury lamp under ambient air and the photoluminescence was monitored at 400 nm and 380 nm for CDM and CDP samples, respectively, for different times ranging from 1 hour to 24 hours. The PL emission intensity was reduced by less than 10% when continuously irradiated for up to 6 hours. The maximum reduction of PL intensity was −24% when the exposure time extended to 24 hours (FIG. 2E, FIG. 10).

The photoluminescent properties for CDM and CDM samples across a range of temperatures have also been evaluated. CDM and CDP were excited at about 380 and 400 nm, respectively, and the resulting PL emission spectra were collected at temperatures ranging from 20 to 100° C. Both CDP and CDM samples showed relative thermal stability with a maximum PL intensity reduction of about 20% (see FIG. 2F, FIGS. 10-10D). This can indicate that CDP and CDM according to exemplary embodiment of the present disclosure can have superior stability and hence can be suitable for practical applications.³⁰

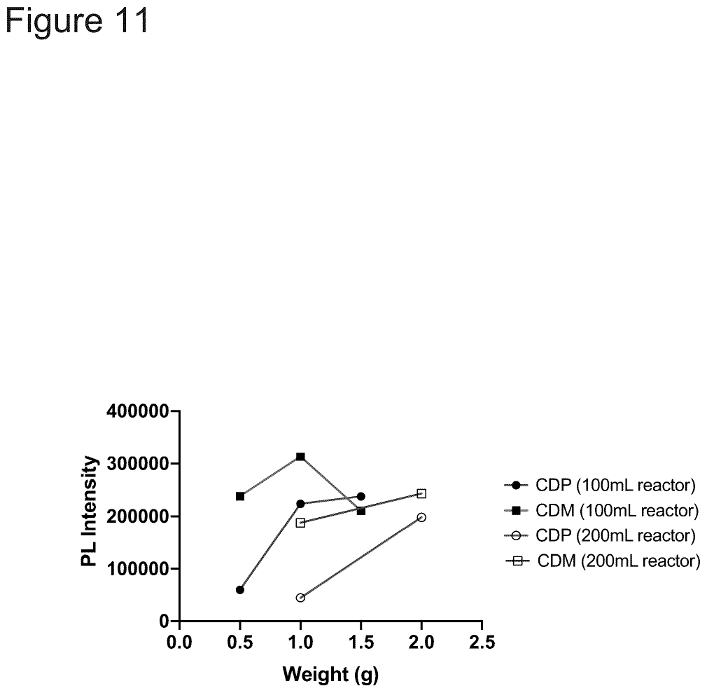

To demonstrate the suitability of the exemplary method, system, product and arrangement according to the exemplary embodiments of the present disclosure for large scale production of CDP and CDM, synthesis has been performed using different plastic bag and mask loads (0.5, 1, 1.5 g) but with the same volume and concentration of nitric acid solution. Increasing the mass of waste processed increased PL intensity of CDP and CDM due to the formation of more carbon dots (FIG. 11). This supports the scalability of the methods according to exemplary embodiments of the present disclosure to produce CDP and CDM at larger industrial scales. The overall process can be scaled up from a 100 mL to 200 mL reactor while retaining efficiency of the process. This supports further scale up to large batch quantities and reactor volumes.

### Exemplary Size and Structure of Carbon Dots

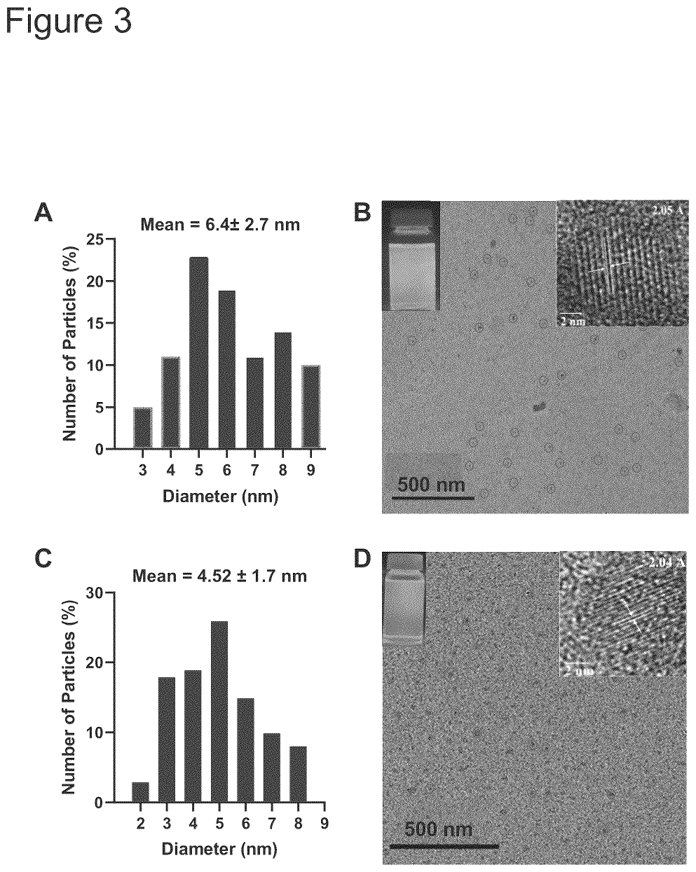

According to exemplary embodiments of the present disclosure, transmission electron microscopy (TEM) can be used to characterize the nanostructure of CDP and CDM. FIGS. 3A-3D show the TEM, size distribution histograms, and HR-TEM results of the synthesized carbon dots according to exemplary embodiments of the present disclosure. The TEM images showed that CDP and CDM are quasi-spherical without noticeable aggregation and agglomeration. The average diameter for CDPs and CDMs are 6.4±2.7 nm and 4.5±1.7 nm, respectively. High-resolution TME (HRTEM) demonstrated that both exemplary CDs have similar crystallinity with average lattice spacing of around 0.2 nm which is assigned to the (100) plane of carbon particles.³¹

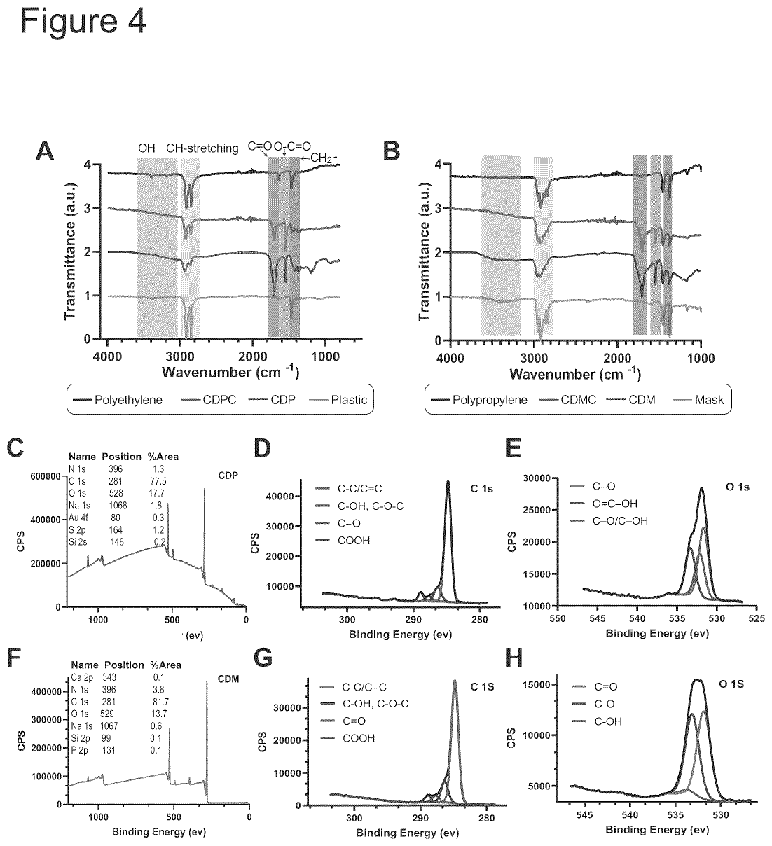

FTIR spectra of the starting materials and products have been collected to identify the nature of the functional groups of the produced CDs (FIG. 4A, 4B). The polyethylene-based plastic bags and Low-density polyethylene (LDPE) showed similar typical absorption bands at 1470 and 2900 cm⁻¹ which can be assigned to CH₂-scissoring and CH-stretching vibration, respectively (FIG. 4A).³² The peak at 1470 cm⁻¹ was completely absent in the spectra of the final products, while the intensity of the band at 2900 cm⁻¹ was significantly lower compared to their counterparts starting materials, which demonstrates the successful transformation of plastic bags and LDPE into a new material. Furthermore, some new absorbance bands appeared in the spectra of the final products. Both CDP and CDPC exhibited a broad absorption band over 3000 cm⁻¹, which can be attributable to COOH or C—OH. Moreover, two new bands appeared at 1701 and 1546 cm⁻¹, which can be assigned to C═O and C═C, respectively.³³

Exemplary FTIR data of the exemplary polypropylene-based mask wastes and exemplary low-density polypropylene (LDPP) showed the typical absorption peaks of polypropylene at 2900, 1452, and 1375 cm⁻¹, which can be assigned to the sp³ CHₓ, and the bending of CH₃ and CH₂, respectively (FIG. 4B).³³ The exemplary products CDM and CDMC showed new absorption bands at 1704, 1545, 1456 which can be assigned to COOH/OH, C═O, and C═C, respectively.³³ This can confirm the successful synthesis of hydroxyl and/or carboxyl-containing carbon dots from plastic and mask wastes. CDPC and CDMC exhibited similar bands to these of CDP and CDM, confirming that the synthetic method, systems, products and arrangements according to an exemplary embodiment of the present disclosure can indeed convert contaminated plastics into CDs as well.

To further confirm the functional groups on the surface of the CDs, XPS spectroscopy has been performed. The survey scan of CDP and CDM revealed that they are mainly composed of carbon and oxygen. CDPs were composed of 77.5% carbon and 17.7% oxygen, while CDMs of 81.7% carbon and 13.7% oxygen (see FIGS. 4C and 4F). Various figures of FIGS. 4A-4D illustrate the exemplary high resolution XPS spectra of C 1 s and O1 s. The deconvoluted peaks of C is appeared at 284.8, 286.4, 287.7, and 288.9 eV for both CDP and CDM (see FIGS. 4D and 4G). These can be assigned to C—C/C═C, C—O, C═O, and COOH, respectively.³⁴ The deconvoluted peaks of O 1 s for CDP showed at 531.7, 532.1, and 533.3 eV (see FIG. 4E) while these for CDM appeared at 531.9, 533.1, and 533.6 eV (FIG. 4H). These can be attributed to C═O, C—O/C—OH, and O═C—OH bonding, respectively.³⁵ The XPS data are consistent with the FTIR data, providing convincing evidence for the nature of the functional groups on the surface of the CDs for CDP and CDM.

### Exemplary Cytotoxicity of CDs

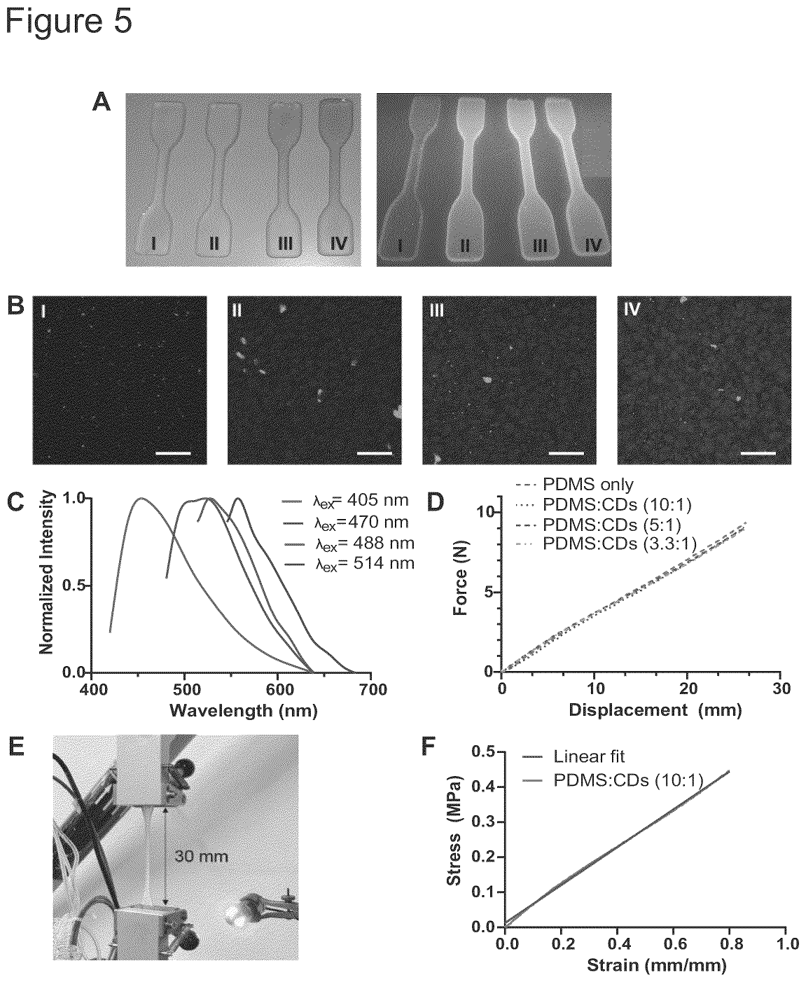

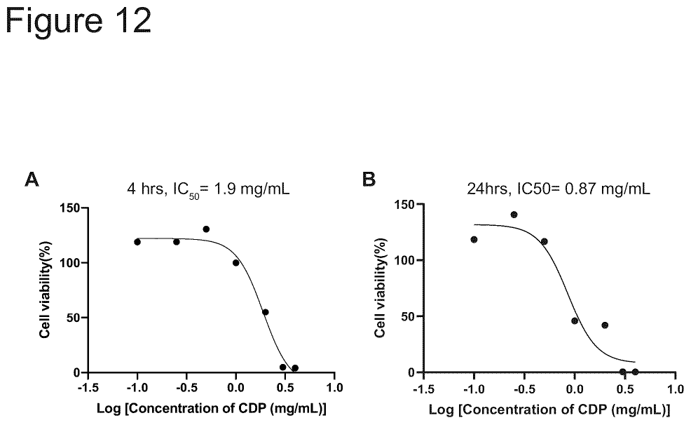

To assess the safety of the CDs to be used for various applications, cellular cytotoxicity MTT assay was performed on HeLa cells. MTT assay was performed with increasing concentration of CDPs (0, 0.1, 0.25, 0.5, 1, and 2 mg/ml) on HeLa cells and the cell viability was determined after 4 hours of incubation (see FIGS. 5A and 5B). MTT assay revealed that, cell viability was negligibly affected at concentrations 0.1-1 mg/ml, while cell viability decreased to −55% as the concentration of CDP increased up to 2 mg/ml (see FIGS. 12A and 12B). This indicates that the CDP of 1 mg/ml concentration does not affect the overall cell viability and can be suitable to be used for in vitro and in vivo applications.

### Exemplary Stretchable Fluorescent Polymers

According to an exemplary embodiment of the present disclosure, an exemplary application is provided where the generated CDs could be readily applied. For example, CDs has been incorporated into polymers, towards creating physical anti-counterfeiting films. According to an exemplary embodiment, CDs can endow flexible polymers with fluorescent properties. Incorporating fluorescent materials into stretchable substrates can yield films of arbitrary shapes with fluorescent properties³⁶⁻³⁸, and have been utilized in semiconductor devices,³⁹ artificial intelligence,^{40,41} sensors,⁴² and artificial human skin.⁴³ According to an exemplary embodiment of the present disclosure, stretchable anticounterfeiting devices can be constructed from CD-doped polymers, leveraging the photo- and thermal stability of the CDs.⁴⁴

According to an exemplary embodiment of the present disclosure, a stretchable excitation-dependent emission, photoluminescence-tunable polydimethylsiloxane (PDMS) film has been developed by mixing PDMS substrate with CDP. Optical and mechanical characterization tests were performed on exemplary dog-bone-shaped PDMS samples with varying CDP concentrations (10:0 (I), 10:1 (II), 5:1 (III), and 3.3:1 (IV) of PDMS:CDP). FIG. 5A shows both the control and CDP-doped PDMS films under visible light (panel A left) and under UV irradiation (panel A right, at a wavelength of 365 nm). Samples (II, III, and IV) showed blue fluorescence, while the control sample (I) showed no fluorescence when exposed to UV light. The distribution of CDP within the PDMS film was investigated using spectral confocal microscope. Exemplary results showed a homogenous distribution of CDP within the PDMS film at high and low loading concentration of CDP (FIG. 5B). To demonstrate the excitation-dependent emission property of the PDMS film, sample II was excited at 405, 470, 488 and 514 nm using a spectral confocal microscope which gave emission spectra centered at 454, 522, 527, and 557 nm, respectively. Such a unique property is difficult to replicate and supports the potential utility as a stretchable, anticounterfeiting device.

Mechanical properties testing has been performed following the ASTM D412 Type C standard. The sample was uniaxially deformed by 30 mm at a displacement rate of 5 mm/s and the change was recorded in the force values using a 5 kN load cell. No significant change was observed in the force-displacement behavior among control and CDP-doped samples (see FIG. 5D). Using the PDMS+CD (10:1) sample, Young's modulus of elasticity was estimated via the associated engineering stress-strain response (see FIG. 5F). The strained response was linearly fitted to obtain the slope, which was recorded to be 0.5398. A factor of 0.5 was used to multiply with the obtained slope. The conversion factor used to account for the difference between engineering and true stress-strain behavior⁴⁵. A modulus value of 1.07 MPa was obtained, which typically represents the modulus of Sylgard™ 184 PDMS (with the curing agent, 10:1).^{46,47} Thus, no change in modulus was observed for the samples doped with CDs, illustrating the stable nature of the CPD with PDMS material.

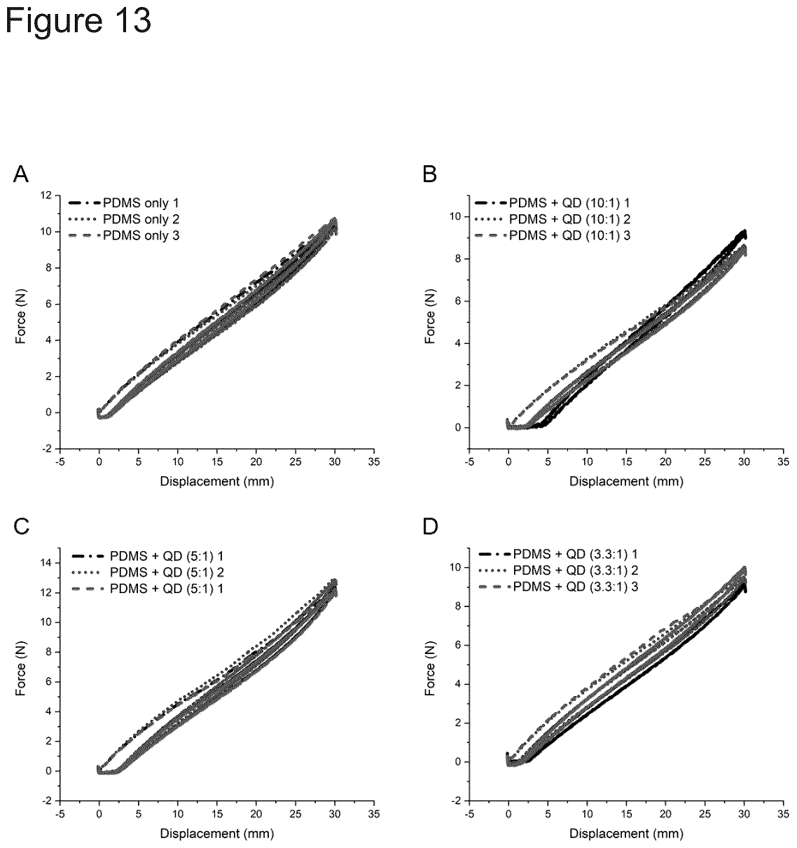

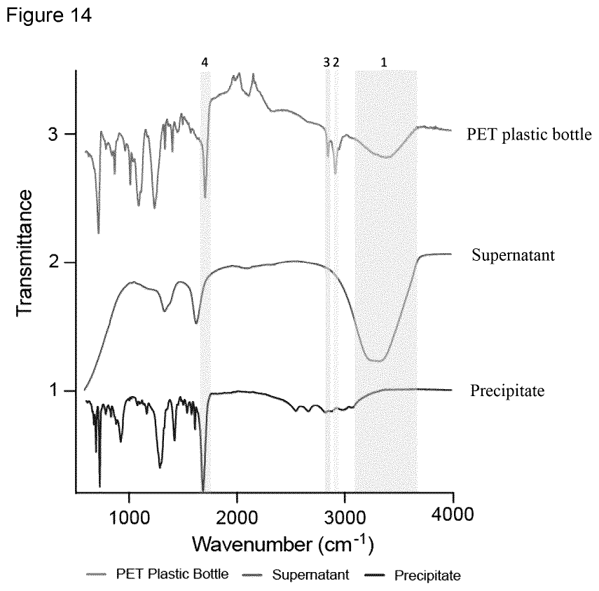

In order to characterize the stability of the CDP-doped PDMS samples with repeatable deformation, cyclic deformation tests were performed on the four samples, with three replicates of each (FIG. 13). The samples were cyclically deformed and brought back to their original position, and the associated change in the force was recorded. FIG. 13A shows the exemplary response for the PDMS only control. The responses were highly repeatable with minimal hysteresis loss. The response confirms that PDMS (with curing agent, 10:1) can be used for a large number of deformation cycles without undergoing significant material change (time-dependent material response) as it efficiently dissipates strain energy (4). FIGS. 13B-13D show the exemplary cyclical response for PDMS samples doped with varying concentrations. All the samples showed repeatable and similar responses with respect to the control samples and thus highlighted no significant change in the associated mechanical properties due to the addition of CDs. Little or no considerable change in the modulus as well as hysteresis behavior occurred due to the doping of the CDs in the PDMS network.

Anti-counterfeiting techniques can range in complexity from simple luminescent inks, identified by a single emission color regardless of excitation, to randomized physically unclonable functions (PUFs)⁴⁸. The CD-doped polymers according to certain exemplary embodiments of the present disclosure could be used to provide robust, affordable anti-counterfeit and tamper-resistant stretchable labels for packages containing sensitive materials such as medications. Unlike conventional dyes, CDs exhibit excitation-dependent emission which allows for tuning the fluorescence spectra by changing the excitation wavelength. The approach according to exemplary embodiments of the present disclosure would also avoid the need for dual beginning and end authentication of spectra through consistent, large-scale batch fabrication yielding well characterized photoluminescent properties for films. Further security features could be incorporated by, for example, varying the average diameter of CDs doped in each batch, yielding a change in the ratio between excitation-dependent emission peaks.

### Exemplary Discussion of Economic Impact

One of the goals of a circular plastics economy is more advanced recycling mechanisms for common plastics⁴⁹. One-step, solvent-free oxidative degradation for polypropylene and polyethylene, according to exemplary embodiments of the present disclosure, can assist with shifting away from the existing linear pipeline of plastics use, as it is less polluting than mechanical recycling and incineration and cheaper than existing methods of chemolysis⁵⁰. Exemplary techniques exploiting the reuse and recovery of plastic resource could also entail a significant economic output⁵¹ through the valorization of plastics. the combined benefit of waste reduction and value creation could contribute towards the UN sustainable development goal (SDG) of “Responsible consumption and production”.

The economic feasibility of the synthetic method to upcycle plastics into valuable CDs has been estimated, according to an exemplary embodiment of the present disclosure, by comparing the cost of this process to (1) existing chemical recycling processes and (2) economic value of the created CDs. Using large-scale cost estimates for nitric acid and electricity of $0.58/L and $0.12/Kwh, respectively, it has been estimated, according to an exemplary embodiment of the present disclosure, a processing cost of $5/kg ($5000/ton) of plastic waste using the methods of the present disclosure. This cost can be further decreased to $3,670/ton by increasing mass of plastic waste within each cycle (see FIG. 11). In comparison, existing mechanical and chemical recycling methods cost —$1000/ton of plastic waste. The methods, systems, products and arrangements according to exemplary embodiments of the present disclosure, however, not only recycle plastic but yield CD products with economic value. Conservatively estimating a 60% yield (600 g CDs/1 kg plastic), produced CDs have an approximate market value of $1800/kg of plastic. Notwithstanding the approximations in this model, it is clear that the increased cost of the synthetic upcycling method according to exemplary embodiments of the present disclosure is compensated by the value of the products created. There is also a demand for CDs at such scales. The global market value of quantum dots has been gaining a market growth in the forecast period of 2020 to 2025 with a compound annual growth rate (CAGR) of 26.6% and is expected to reach $6.412 billion by 2025, up from $2.496 billion in 2019. 52 Thus, the high commercial value of the produced CDs outweighs the related cost to process the plastic wastes.

According to an exemplary embodiment of the present disclosure, a hydrothermal facile, solvent free, one-pot synthetic route to convert polyethylene-based plastic bags and polypropylene-based mask waste into CDs can be provided. The concentration of HNO₃, temperature, and reaction time during the reaction can be adjusted to yield blue-fluorescent CDs. The produced CDs can contain, e.g., oxygen-functionalized groups (such as COOH, OH) as demonstrated by FTIR and XPS spectroscopy. Based on the analyzed results, according to exemplary embodiments of the present disclosure, the hydrothermal treatment of polyethylene and polypropylene polymers form carbon dots similar to the polyaromatic hydrocarbon clusters, such as furan-based polymers or carbon, and the carbon dots consist of sp² and sp³ carbons with unique luminescence properties. Such exemplary method, system, product and arrangement according to exemplary embodiments of the present disclosure can be advantageous over other methods due to, e.g., green and solvent-free synthesis, high reaction yield, single step, relatively low temperature, high solubility of CDs in aqueous media, and excitation-dependent photoluminescence properties. The exemplary methods, processes, systems, products and arrangements of the present disclosure can also be used on contaminated plastics, which is a major issue with current recycling methods and arrangements. The exemplary economic analysis reveals the sustainability of this approach compared with existing recycling methods and arrangements. The synthesized CDs can be used in various applications, including as anticounterfeiting agents to secure stretchable polymers and devices.

The exemplary embodiments of the present disclosure are illustrated herein by the following examples, which should not be construed as limiting. The contents of all references, pending patent applications and published patents, cited throughout this application are hereby expressly incorporated by reference. Those skilled in the art will understand that these exemplary embodiments of the present disclosure may be embodied in many different forms and should not be construed as limited to the embodiments set forth herein. Rather, these exemplary embodiments are provided so that the present disclosure will fully convey the exemplary embodiment of the present disclosure to those skilled in the art. Various exemplary modifications and other exemplary embodiments of the present disclosure will come to mind in one skilled in the art to which this invention pertains having the benefit of the teachings presented in the foregoing description. Although specific terms are employed, they are used as in the art unless otherwise indicated.

### EXAMPLES

### Exemplary Materials and Methods

### Exemplary Synthesis of CDs.

The CDs were synthesized following an oxidative degradation pathway. In a typical experiment, 0.5 g of the polyethylene-based trash bag was added to 20 ml of nitric acid solution (0.15 g/ml). The mixture was heated to 180° C. using autoclave reactor for 12 hours. The aqueous portion of the product (CDP) was transferred into a beaker and the solid residue in the autoclave reactor was washed 3 times with distilled water. Methanol was then added to dissolve all the remaining black residue in the autoclave reactor. Both portions of the products were purified using dialysis against methanol (MWCO of 1 KDa, SPECTRA/POR® 6 Standard RC Pre-wetted Dialysis Tubing, diameter 29 mm). The previous procedures were repeated for polypropylene-based face masks as the carbon source to produce CDM (see FIG. 7—Scheme 1). For synthesis testing in the presence of organic contaminants, 0.4 g of plastics was with 0.1 g of organic waste [mixture of eggs (60%), tomato sauce (20%), and peanut butter (20%)].

### Exemplary Materials

Nitric acid (puriss. p.a., 65.0-67.0%) was purchased from Sigma-Aldrich. Clear trash bags [Aluf Plastics, HDPE (High Density Polyethylene)] and disposable 3-Ply face masks (SP-LAMP, Polypropylene) were used as the carbon source. Low density polyethylene (LDPE) and low-density polypropylene (LDPP). All chemicals and materials were used as received.

### Exemplary Scalability

The CDs of each batch were made using the method described here. In a typical reaction, an amount of plastic waste of 0.5, 1, and 1.5 g each is immersed in 20 ml of nitric acid solution (0.15 g/ml) in an autoclave reactor. The mixture was heated at 180° C. for 12 hrs and the produced carbon dots were purified using a combination of centrifugation and dialysis.

### Exemplary Characterization

XPS analyses were carried out using a Kratos Axis Nova spectrometer utilizing a monochromatic Al K(alpha) source (15 mA, 14 kV). The TEM images were recorded using Libra 200 MC operated at 150 kV. It is worth mentioning that the bright field images of the carbon-based sample cannot be easily distinguishable due to the low contrast between CDs and carbon coated copper grids. The obtained average diameter was determined by analyzing of more than 180 dots from different regions of the grid. The FTIR spectra were measured using a Nicolet 6700 FTIR spectrometer equipped with a smart iTR diamond horizontal attenuated total reflectance (ATR).

The UV-Vis absorption spectra were recorded using a Shimadzu UV-1800 double beam spectrophotometer with a 1 cm path length quartz cuvette. Steady-state emission and excitation spectra were recorded on a Photon Technology International (PTI) spectrofluorometer equipped with a xenon short-arc lamp. All measurements carried out using Felix X32 PTI software for data collection and analysis at 298 K under ambient oxygen. The confocal microscope measurements were carried out using Leica Microsystems (SP8) in xyλ mode. The Detection bandwidth was 10 nm and the step size 3 nm. The excitation lasers were 405, 470 488 and 514 nm.

Fluorescence quantum yields were measured using the optically dilute method. A stock solution with an absorbance of around 0.5 was prepared and then four different dilutions were prepared with dilution factors between 2 and 20 to give solutions with absorbances of 0.094 0.066, 0.052 and 0.019, respectively. The emission spectra were then measured. Individual relative quantum yield values were calculated for each solution and the values reported represent the slope value. The equation Φs=Φr(A r/A s)(I s/I r)(ns/nr)⁵³ was utilized to calculate the relative quantum yield of each of the sample, where (Dr is the absolute quantum yield of the reference, n is the refractive index of the solvent, A is the absorbance at the excitation wavelength, and I is the integrated area under the corrected emission curve. The subscripts s and r refer to the sample and reference, respectively. A solution of quinine sulfate in 0.5 M H₂SO₄ (Φᵣ=54.6%) was used as an external reference.⁵⁴

### Exemplary MTT Protocol

The level of cytotoxicity of the CDP was determined against HeLa cells using MTT (3-(4,5-dimethyl-2-yl)-2,5-diphenyltetrazolium bromide) proliferation assay (Abcam ab211091). A concentration of 10⁴ HeLa cells were seeded in 96 well plates containing 100 μl of Dulbecco's Modified Eagle Medium (Thermo Fisher, 11965092), supplemented with 10% (v/v) fetal bovine serum (Sigma F0804) and 100 U/mL penicillin and 0.1 mg/mL streptomycin solution (Sigma P0781-100ML) in each microwell. The cells were kept at 37° C. in a CO₂ incubator with an atmosphere of 5% CO₂ in 95% humidified air and were allowed for 48 hours to reach optimal population densities. Per triplicate, different concentrations (0.1, 0.25, 0.5, 1, 2 mg/ml) of CDP were added into the well of the microplates and incubated in CO₂ incubator for 4 and 24 hours. After incubation time, the procedure was done following the instructions of the manufacturer. Then, the absorbance was analyzed using a Microplate Reader at 590 nm and the cell viability was calculated using:

Percentage of Cell viability (%)=(Treatment/Control)×100.

### Exemplary Development and Characterization of Anti-Counterfeiting Fluorescent PDMS

The fabrication of fluorescent PDMS involved mixing PDMS polymer with silicon-based curing agent (SYLGARD 184 silicone elastomer) in a ratio of 10:1 and followed by the addition of different volumes of carbon dots suspended in tetrahydrofuran (THF). The PDMS film was fabricated by mixing PDMS substrate with CDP. Optical and mechanical characterization tests were performed on dog-bone-shaped PDMS samples with varying CPD concentrations (10:0 (I), 10:1 (II), 5:1 (III), and 3.3:1 (IV) of PDMS:CDP). Mechanical properties testing were performed following the ASTM D412 Type C standard. Using an Instron® universal testing machine, the sample was uniaxially deformed by 30 mm in a displacement-controlled way with a displacement rate of 5 mm/s and the change recorded in the force values using a 5 kN load cell.

### Exemplary Sample Economic Analysis

The main contributors to the cost of the method described here are the nitric acid solution and power needed for the hydrothermal process. The average price of nitric acid was evaluated at $420/ton during the first quarter of 2022 as per Chemanalyst website (https://www.chemanalyst.com/), or $0.58/1. According to the reported data that was developed according to the exemplary embodiments of the present disclosure, processing 0.5 g of plastics require 20 ml of 0.15 g/ml nitric acid solution (2 ml concentrated nitric acid added to 18 ml of DI water). Therefore, it is important to use 41 of concentrated nitric acid solution for 1 kg processed plastic waste which costs around $2.35/kg. The cost of electricity consumption when using an oven of a power of 2 KW for 12 hrs is $2.88 (assuming the price of 1 kw is 12 cents). Thus, the total cost to process 1 kg of plastics using this method is $5, which is equivalent to $5000 per ton of plastic. At a large-scale production, the cost of using an oven of 3000 l capacity and a power of 36 KW for 12 hrs will be $4.3 for each 3000 l (1 cycle). To process 1 ton of the plastic waste, it is required to utilize 40,000 l of 0.15 g/ml nitric acid solution which can be performed in 13 cycles which brings the total electricity consumption to $57. Costs can be further reduced by increasing the weight of the processed plastic waste in the same volume of nitric acid to be 1.5 g of plastic instead of 0.5 g for each 20 ml of nitric acid solution which will reduce the cost of nitric acid significantly by more than 50%. The method described here can produce a minimum of 600 g CDs for each 1 kg processed plastic waste. The average commercial price of carbon dots is estimated to be around $300 per 100 gm of quantum dots. Therefore, 1 g of CDs brings a value of more than $3000/g.

### Example 1

For example, 0.5 g of plastic bag made of polyethylene polymer was weighed and immersed in 20 ml of nitric acid solution (0.15 g/ml). The mixture was transferred to a polytetrafluoroethylene hydrothermal autoclave reactor, and the hydrothermal reaction was carried out at 180° C. for 12 hours. After the reaction was completed, the formed yellow carbon dot solution was filtered and purified utilizing dialysis against water to remove nitric acid and other impurities (MWCO of 1 KDa, SPECTRA/POR® 6 Standard RC Pre-wetted Dialysis Tubing, diameter 29 mm). The synthesized carbon dots emitted blue light under the irradiation of a UV lamp.

### Example 2

For example, 0.5 g of face mask made of polypropylene polymer was weighted and immersed in 20 ml of nitric acid solution (0.15 g/ml). The mixture was transferred to a polytetrafluoroethylene hydrothermal autoclave reactor, and the hydrothermal reaction was carried out at 180° C. for 12 hours. After the reaction was completed, the formed yellow carbon dot solution was filtered and purified utilizing dialysis against water to remove nitric acid and other impurities (MWCO of 1 KDa, SPECTRA/POR® 6 Standard RC Pre-wetted Dialysis Tubing, diameter 29 mm). The synthesized carbon dots emitted blue light under the irradiation of a UV lamp.

### Example 3

For example, 0.4 g of polyethylene-based plastic or polypropylene-based mask and 0.1 g of organic waste [mixture of eggs (60%), tomato sauce (20%), and peanut butter (20%)] were weighed and immersed in 20 ml of nitric acid solution (0.15 g/ml). The mixture was transferred to a polytetrafluoroethylene hydrothermal autoclave reactor, and the hydrothermal reaction was carried out at 180° C. for 12 hours. After the reaction was completed, the formed yellow carbon dot solution was filtered and purified utilizing dialysis against water to remove nitric acid and other impurities (MWCO of 1 KDa, SPECTRA/POR® 6 Standard RC Pre-wetted Dialysis Tubing, diameter 29 mm). The synthesized carbon dots emitted blue light under the irradiation of a UV lamp.

### Example 4

An example of a hydrothermal treatment was performed as follows.

In an exemplary experiment, 0.5 g of the Polyethylene terephthalate plastic bottle was added to 20 ml of nitric acid solution (0.15 g/ml). The mixture was heated to 180° C. using autoclave reactor for 12 hours. The aqueous portion of the product was transferred into a beaker and the solid residue in the autoclave reactor was washed 3 times with distilled water. Methanol was then added to dissolve all the remaining black residue in the autoclave reactor. Both portions of the products were purified using dialysis against methanol (MWCO of 1 KDa, SPECTRA/POR® 6 Standard RC Pre-wetted Dialysis Tubing, diameter 29 mm).

The FTIR analysis of the reaction product reveals the vanishing, shifting, and emergence of certain functional groups inherent to the PET-based plastic bottle. The employed hydrothermal method yields a white precipitate and a distinct discoloration of the solution. Subsequent data indicates the dominance of specific functional groups in one sample over another. For instance, the supernatant exhibits increased acidity relative to other samples, as evidenced by the broad peak (1). This peak is attributed to the —OH group of a carboxylic acid. Conversely, peaks (2) and (3), associated with the C—H stretch of alkanes, are present in the PET bottle structure but do not appear after processing. The carbonyl stretching, denoted by peak (4), shows a minor shift in the supernatant but persists in both the untreated PET bottle and the precipitate.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### EXEMPLARY REFERENCES

The following reference is hereby incorporated by references in their entireties:
1 Peng, Y., Wu, P., Schartup, A. T. & Zhang, Y. Plastic waste release caused by COVID-19 and its fate in the global ocean. Proceedings of the National Academy of Sciences 118 (2021).
2 MacArthur, E. The new plastics economy: Rethinking the future of plastics & catalysing action. Ellen MacArthur Foundation 68 (2017).
3 Aragaw, T. A. Surgical face masks as a potential source for microplastic pollution in the COVID-19 scenario. Marine Pollution Bulletin 159, 111517 (2020).
4 Tokiwa, Y., Calabia, B. P., Ugwu, C. U. & Aiba, S. Biodegradability of plastics. International journal of molecular sciences 10, 3722-3742 (2009).
5 Legrand, P. et al. Development of an HPLC/UV method for the evaluation of extractables and leachables in plastic: Application to a plastic-packaged calcium gluconate glucoheptonate solution. Journal of Pharmaceutical and Biomedical Analysis 155, 298-305 (2018).
6 Mooney, D. et al. The Life of a Face Mask: from Production to Use to Disposal. ScienceOpen Preprints (2021).
7 Du, H., Huang, S. & Wang, J. Environmental risks of polymer materials from disposable face masks linked to the COVID-19 pandemic. Science of The Total Environment, 152980 (2022).
8 Celik, G. et al. Upcycling single-use polyethylene into high-quality liquid products. ACS central science 5, 1795-1803 (2019).
9 Al Rayaan, M. B. Recent advancements of thermochemical conversion of plastic waste to biofuel-A review. Cleaner Engineering and Technology, 100062 (2021).
10 Sharma, B., Shekhar, S., Sharma, S. & Jain, P. The paradigm in conversion of plastic waste into value added materials. Cleaner Engineering and Technology 4, 100254 (2021).
11 Nisar, J. et al. Production of fuel oil and combustible gases from pyrolysis of polystyrene waste: Kinetics and thermodynamics interpretation. Environmental Technology & Innovation 24, 101996 (2021).
12 Agenda, I. in World Economic Forum. 36.
13 Tian, X. et al. Carbon quantum dots: In vitro and in vivo studies on biocompatibility and biointeractions for optical imaging. International journal of nanomedicine 15, 6519 (2020).
14 Boakye-Yiadom, K. O. et al. Carbon dots: Applications in bioimaging and theranostics. International Journal of Pharmaceutics 564, 308-317, doi:https://doi.org/10.1016/j.ijpharm.2019.04.055 (2019).
15 Long, C. et al. Applications of carbon dots in environmental pollution control: A review. Chemical Engineering Journal 406, 126848, doi:https://doi.org/10.1016/j.cej.2020.126848 (2021).
16 Li, Y., Yang, H.-P., Chen, S., Wu, X.-J. & Long, Y.-F. Simple Preparation of Carbon Dots and Application in Cephalosporin Detection. Journal of Nanoscience and Nanotechnology 21, 6024-6034 (2021).
17 Zeng, Q. et al. Carbon dots as a trackable drug delivery carrier for localized cancer therapy in vivo. Journal of Materials Chemistry B 4, 5119-5126 (2016).
18 Nocito, G. et al. Carbon dots as promising tools for cancer diagnosis and therapy. Cancers 13, 1991 (2021).
19 Guo, J. et al. Green synthesis of carbon dots toward anti-counterfeiting. ACS Sustainable Chemistry & Engineering 8, 1566-1572 (2019).
20 Hu, Y., Li, M., Gao, Z., Wang, L. & Zhang, J. Waste polyethylene terephthalate derived carbon dots for separable production of 5-hydroxymethylfurfural at low temperature. Catalysis Letters 151, 2436-2444 (2021).
21 Hu, Y., Gao, Z., Yang, J., Chen, H. & Han, L. Environmentally benign conversion of waste polyethylene terephthalate to fluorescent carbon dots for “on-off-on” sensing of ferric and pyrophosphate ions. Journal of colloid and interface science 538, 481-488 (2019).
22 Chaudhary, S., Kumari, M., Chauhan, P. & Chaudhary, G. R. Upcycling of plastic waste into fluorescent carbon dots: An environmentally viable transformation to biocompatible C-dots with potential prospective in analytical applications. Waste Management 120, 675-686 (2021).
23 Lauria, A. & Lizundia, E. Luminescent carbon dots obtained from polymeric waste. Journal of Cleaner Production 262, 121288 (2020).
24 Kumari, M. & Chaudhary, S. Modulating the physicochemical and biological properties of carbon dots synthesised from plastic waste for effective sensing of E. coli. Colloids and Surfaces B: Biointerfaces 196, 111333 (2020).
25 Song, H., Liu, X., Wang, B., Tang, Z. & Lu, S. High production-yield solid-state carbon dots with tunable photoluminescence for white/multi-color light-emitting diodes. Science Bulletin 64, 1788-1794 (2019).
26 Ramanan, V., Siddaiah, B., Raji, K. & Ramamurthy, P. Green synthesis of multifunctionalized, nitrogen-doped, highly fluorescent carbon dots from waste expanded polystyrene and its application in the fluorimetric detection of Au3+ ions in aqueous media. ACS Sustainable Chemistry & Engineering 6, 1627-1638 (2018).
27 Backstrom, E., Odelius, K. & Hakkarainen, M. Trash to treasure: microwave-assisted conversion of polyethylene to functional chemicals. Industrial & Engineering Chemistry Research 56, 14814-14821 (2017).
28 Li, H., Kang, Z., Liu, Y. & Lee, S.-T. Carbon nanodots: synthesis, properties and applications. Journal of materials chemistry 22, 24230-24253 (2012).
29 Taghavi, N., Udugama, I. A., Zhuang, W.-Q. & Baroutian, S. Challenges in biodegradation of non-degradable thermoplastic waste: From environmental impact to operational readiness. Biotechnology Advances 49, 107731, doi:https://doi.org/10.1016/j.biotechadv.2021.107773 (2021).
30 Javed, N. & O'Carroll, D. M. Carbon dots and stability of their optical properties. Particle & Particle Systems Characterization 38, 2000271 (2021).
31 Hu, Q., Gong, X., Liu, L. & Choi, M. M. F. Characterization and Analytical Separation of Fluorescent Carbon Nanodots. Journal of Nanomaterials 2017, 1804178, doi:10.1155/2017/1804178 (2017).
32 Backström, E., Odelius, K. & Hakkarainen, M. Trash to Treasure: Microwave-Assisted Conversion of Polyethylene to Functional Chemicals. Industrial & Engineering Chemistry Research 56, 14814-14821, doi:10.1021/acs.iecr.7b04091 (2017).
33 Adolfsson, K. H., Lin, C.-f. & Hakkarainen, M. Microwave assisted hydrothermal carbonization and solid state postmodification of carbonized polypropylene. ACS Sustainable Chemistry & Engineering 6, 11105-11114 (2018).
34 Zhang, J. et al. A simple approach for synthesizing of fluorescent carbon quantum dots from tofu wastewater. Nanoscale Research Letters 12, 1-7 (2017).
35 Liu, Q. et al. Nitrogen-doped carbon dots for sensitive detection of ferric ions and monohydrogen phosphate by the naked eye and imaging in living cells. Nanoscale Advances 3, 805-811 (2021).
36 Liu, X., Wang, J., Tang, L., Xie, L. & Ying, Y. Flexible plasmonic metasurfaces with user-designed patterns for molecular sensing and cryptography. Advanced Functional Materials 26, 5515-5523 (2016).
37 Park, D. H., Hong, J., Park, I. S., Lee, C. W. & Kim, J. M. A colorimetric hydrocarbon sensor employing a swelling-induced mechanochromic polydiacetylene. Advanced Functional Materials 24, 5186-5193 (2014).
38 Que, M. et al. Flexible quantum dot-sensitized solar cells employing CoS nanorod arrays/graphite paper as effective counter electrodes. Journal of Materials Chemistry A 2, 13661-13666 (2014).
39 Walia, C. & Shah, P. G. H. Nili, DR Chowdhury, W. Withayachumnankul, M. Bhaskaran, and S. Sriram. Appl. Phys. Rev 2, 011303 (2015).
40 Wang, X. et al. Self-powered high-resolution and pressure-sensitive triboelectric sensor matrix for real-time tactile mapping. Advanced materials 28, 2896-2903 (2016).
41 Cao, X. et al. Piezotronic effect enhanced label-free detection of DNA using a Schottky-contacted ZnO nanowire biosensor. ACS nano 10, 8038-8044 (2016).
42 Bao, R. et al. Flexible and controllable piezo-phototronic pressure mapping sensor matrix by ZnO NW/p-polymer LED array. Advanced Functional Materials 25, 2884-2891 (2015).
43 Wang, X. et al. Recent progress in electronic skin. Advanced Science 2, 1500169 (2015).
44 Liu, J., Li, R. & Yang, B. Carbon Dots: A New Type of Carbon-Based Nanomaterial with Wide Applications. ACS central science 6, 2179-2195, doi:10.1021/acscentsci.0c01306 (2020).
45 Baban, N. S., Orozaliev, A., Stubbs, C. J. & Song, Y. A. Understanding interfacial fracture behavior between microinterlocked soft layers using physics-based cohesive zone modeling. Physical Review E 102, 012801 (2020).
46 Sofela, S. et al. in Micro and Nano Systems for Biophysical Studies of Cells and Small Organisms 261-293 (Elsevier, 2021).
47 Baban, N. S., Orozaliev, A., Stubbs, C. J. & Song, Y.-A. Biomimicking interfacial fracture behavior of lizard tail autotomy with soft microinterlocking structures. Bioinspiration & Biomimetics (2022).
48 Arppe, R. & Sorensen, T. J. Physical unclonable functions generated through chemical methods for anti-counterfeiting. Nature Reviews Chemistry 1, 1-13 (2017).
49 Aurisano, N., Weber, R. & Fantke, P. Enabling a circular economy for chemicals in plastics. Current Opinion in Green and Sustainable Chemistry 31, 100513, doi:https://doi.org/10.1016/j.cogsc.2021.100513 (2021).
50 Kaur, G., Uisan, K., Ong, K. L. & Ki Lin, C. S. Recent Trends in Green and Sustainable Chemistry & Waste Valorisation: Rethinking Plastics in a circular economy. Current Opinion in Green and Sustainable Chemistry 9, 30-39, doi:https://doi.org/10.1016/j.cogsc.2017.11.003 (2018).
51 Bucknall, D. G. Plastics as a materials system in a circular economy. Philosophical Transactions of the Royal Society A: Mathematical, Physical and Engineering Sciences 378, 20190268, doi:doi:10.1098/rsta.2019.0268 (2020).
52 GloballnfoResearch. Global Quantum Dot Market 2020 by Manufacturers, Regions, Type and Application, Forecast to 2025. 106 (2020).
53 Melhuish, W. H. Quantum efficiencies of fluorescence of organic substances: effect of solvent and concentration of the fluorescent solute1. The Journal of Physical Chemistry 65, 229-235 (1961).
54 Brouwer, A. M. Standards for photoluminescence quantum yield measurements in solution (IUPAC Technical Report). Pure and Applied Chemistry 83, 2213-2228 (2011).
55. Ogundairo T, Olukanni D, Akinwumi I, Adegoke D. A review on plastic waste as sustainable resource in civil engineering applications. IOP Conference Series: Materials Science and Engineering; 2021: TOP Publishing. p. 012019.
56. Clark J H, Alonso J A, Villalba J A, Aguado J, Serrano D P, Serrano D. Feedstock recycling of plastic wastes: Royal society of chemistry; 1999.
57. Udom P, Phumchusri N. A comparison study between time series model and ARIMA model for sales forecasting of distributor in plastic industry. IOSR Journal of Engineering 2014; 4:32-8.
58. Das R K, Sanyal D, Kumar P, Pulicharla R, Brar S K. Science-society-policy interface for microplastic and nanoplastic: Environmental and biomedical aspects. Environmental Pollution 2021:117985.
59. Zhang H, Liu N, Zeng Q, et al. Design of polypropylene electret melt blown nonwovens with superior filtration efficiency stability through thermally stimulated charging. Polymers 2020; 12:2341.
60. Agenda I. The New Plastics Economy Rethinking the future of plastics. January; 2016.
61. Hou Q, Zhen M, Qian H, et al. Upcycling and catalytic degradation of plastic wastes. Cell Reports Physical Science 2021; 2:100514.
62. Lin X, Xiong M, Zhang J, et al. Carbon dots based on natural resources: Synthesis and applications in sensors. Microchemical Journal 2021; 160:105604.
63. Ritchie H, Roser M. Plastic pollution. Our World in Data 2018.
64. Quantum Dot Market with COVID-19 Impact Analysis by Material, Product, Vertical And Geography—Global Forecast to 2026 2021:236.

What is claimed is:

1. A method, comprising:
performing a hydrothermal reaction on a mixture comprising a product containing a plastic, an acid and water at a temperature in a range of between about 160° C. and 400° C. to obtain a reaction product containing carbon and oxygen.

2. The method of claim 1, wherein the method is a one-pot process.

3. The method of claim 1, wherein the mixture contains no solvent other than water.

4. The method of claim 1, wherein the mixture contains no organic solvent.

5. The method of claim 1, wherein the product containing the plastic comprises polyethylene, polypropylene, polyethylene terephthalate, or a combination thereof.

6. The method of claim 1, wherein the acid is nitric acid, hydrochloric acid, sulfuric acid, or a combination thereof.

7. The method of claim 1, further comprising providing a mixture comprising the product containing the plastic, the acid and water by mixing the product containing the plastic with an aqueous solution containing the acid.

8. The method of claim 1, wherein the hydrothermal reaction is performed at a pressure in a range of about 0.4 MPa to about 3 MPa.

9. The method of claim 1, wherein the reaction product comprises carbon dots.

10. The method of claim 9, wherein the carbon dots emit light having a peak emission wavelength in a range of 340 nm to 490 nm when excited by light having a peak wavelength in a range of 320 nm to 470 nm.

11. The method of claim 9, wherein the carbon dots have an average particle size in a range of 1 nm to 8 nm, as determined by Transmission electron microscopes (TEM).

12. The method of claim 9, wherein the carbon dots have a composition represented by the following formula: C₄—(CH₂)ₙ—(COOH)ₘ or C₄—(CH₂)ₙ—(OH)ₘ.

13. The method of claim 1, wherein the reaction product contains at least one of C—C, C═C, C—O, C═O, —OH, —COOH, or a combination thereof.

14. The method of claim 1, wherein the reaction product comprises a dicarboxylic acid compound.

15. The method of claim 14, wherein the dicarboxylic acid has a composition represented by formula:
HOOC—R—COOH
wherein R is an aliphatic group or an aromatic group containing 3 to 7 carbon atoms, optionally substituted with —OH, —C═O, —NH₂, and COOH.

16. The method of claim 14, wherein the dicarboxylic acid is at least one of malonic acid, succinic acid, glutaric acid, adipic acid, or pimelic acid.

17. The method of claim 1, wherein a content of the product containing the plastic in the mixture is 90% to 96% by weight relative to a total weight of the mixture.

18. A method for converting a product containing a plastic into carbon dots configured to emit a blue light, comprising:
performing a hydrothermal reaction on a mixture comprising the product and an aqueous solution consisting of 0.15 g/ml nitric acid and water, at a temperature of about 160° C. to 400° C. for about 10 hours to 24 hours to obtain the carbon dots configured to emit the blue light,
wherein the mixture contains no solvent other than water.

19. A carbon dot that emits blue light with excitation-dependent emission, wherein the carbon dot is made by converting a product containing a plastic.

20. A dicarboxylic acid compound obtained by the method of claim 14.
